(19) United States
(12) Patent Application Publication
(10) Pub. No.: US 2022/0142758 A1
(43) Pub. Date: May 12, 2022

(54) DEVICE AND METHOD FOR DETECTING JAW RELATION DATA

(71) Applicant: Jörg SCHLIEPER, Henstedt-Ulzburg (DE)

(72) Inventor: Jörg SCHLIEPER, Henstedt-Ulzburg (DE)

(21) Appl. No.: 17/438,906

(22) PCT Filed: Mar. 9, 2020
(86) PCT No.: PCT/EP2020/056140

§ 371 Date: Sep. 13, 2021

(30) Foreign Application Priority Data
Mar. 13, 2019 (DE) 10 2019 106 403.1

(51) Int. Cl. A61C 19/045; A61C 19/05

(52) U.S. Cl. CPC A61C 19/045; A61C 19/05

(57) ABSTRACT

A device for detecting jaw relation data that includes three moveable and interconnected elongated elements: the first extends in a ventral direction and is secured to an upper jaw bearing element; the second extends in a transversal and caudal direction relative to the first; the third extends in the transverse and dorsal direction relative to the second. The second or third elongated element may be configured to be supported on at least one surface of one or more lower jaw tooth crowns or to be arranged at a distance from these crowns in a capturable manner together with the lower jaw tooth crowns by a digital capturing device. A method for detecting jaw relation data may use such a device along with a scanner. Markings on the device may be detected by the scanner to uniquely detect positions of the elongated elements to ascertain jaw relation positions.

### BACKGROUND OF THE INVENTION

### Field of the Invention

One or more embodiments of the invention relate to the field of dentistry devices.

### Description of the Related Art

The present invention relates to a device for detecting jaw relation data of a person. The invention also relates to a method for detecting jaw relation data of a person.

The provision of jaw relation data, i.e., a spatial relation of both jaws to each other and thus the spatial relation of the individual tooth crowns of both jaws to each other, is essential for manufacturing splints in the field of dentistry and oral and maxillofacial surgery, for manufacturing dental prostheses in the field of prosthetics, jaw adjustments in the field of orthodontics, splints for the temporomandibular joint in the field of functional therapy and mandibular advancement splints in the field of dental sleep medicine.

For detecting the jaw relation data, a distinction is made between a static and a dynamic jaw relation: The static jaw relation is the representation of a static situation by means of static three-dimensional position data, i.e., the representation of a relation of the position of the lower jaw to the upper jaw. The dynamic jaw relation is the representation of a dynamic sequence of situations by means of dynamic three-dimensional position data, i.e., the representation of a plurality of relations of the position of the lower jaw to the upper jaw within one motion sequence.

Both the static and the dynamic jaw relation can be identified or registered on the subject by means of devices using passive or active and analog or digital methods. In case of passive methods, the examiner, e.g., the physician, predetermines the position and/or the movement of the lower jaw of the human subject, e.g., by manual or instrumental guidance. This means that the subject does not assume or perform the static or dynamic jaw relation themselves. In contrast, in the active method, the subject performs these movements themselves, if applicable, according to the instructions of the examiner, or assumes the jaw relation position themselves, respectively. There are also combined forms in which, for example, the subject themselves, i.e., actively, assumes a static jaw relation and is passively kept in this position, or the subject actively performs a sequence of situations but under guidance.

The analog and digital methods can be further differentiated between analog and digital methods for static jaw relation and analog and digital methods for dynamic jaw relation. An analog method for static jaw relation uses an impression with impression materials or analog measuring systems. An analog method for dynamic jaw relation uses a plurality of impressions with impression materials or analog measuring systems. A digital method of static or dynamic jaw relation uses digital measuring systems, such as ultrasound, high frequency, or light scanners, in particular so-called intraoral scanners, etc. It is also possible to combine analog and digital as well as passive and active methods. In each case, the respective devices need to be adapted to the respective method.

The devices usually serve to optimize only one or several of these methods and to utilize the analog and/or digital methods in the procedure. In such procedures the devices used are usually bite forks.

Two bite forks, which support a limited active, static and exclusively analog method for determining the jaw relation, are known from DE 103 31 531 A1 and DE 42 92 389 B4. A combined active/passive method is only possible with respect to lower jaw protrusion, i.e., lower jaw advancement or anterior-posterior jaw relation, wherein the subject performs an active protrusion movement of their lower jaw into a specific desired jaw relation, in which they are then kept quasi passively by means of the bite fork. It is not possible to set a variable bite lock, which is characterized by a vertical distance between the upper and the lower teeth, i.e., a cranio-caudal jaw relation. This is disadvantageous because for a desired jaw lock, the bite fork must be manually reworked on the patient. This takes time and is also uncomfortable for the subject because it requires work in the subject's mouth. If the modification does not meet the requirements after it is completed and was checked within the mouth, a remodification (including the above-mentioned disadvantages) is required.

Another disadvantage results from the exclusively analog registration of the jaw relation by means of impression material if the bite lock no longer allows for a simultaneous intraoral scan of the upper and the lower teeth. Furthermore, these bite forks are not suitable for a secure method for active registration, as no secure fixation of the upper teeth in relation to the lower teeth is achieved. This is due to the fact that the devices tend to tilt, since they are, with impression material in between, only positioned between the occlusal surfaces, i.e., the chewing surfaces, of the upper and lower teeth, i.e., they do not cover the entire tooth crowns, with impression material in between, for better retention. In particular, the bite fork disclosed in DE 42 92 389 B4 has a larger bite lock for positioning the jaw relation because it uses two superimposed elements. In DE 103 31 531 A1, a guiding element is provided on the internal side to allow for a reduced bite lock, however, this guiding element often does not withstand the bite force when used.

From DE 10 2014 102 770 A1, a device is known that supports an active, dynamic and digital method for registering the jaw relation, but not a passive, static or dynamic method (fixation or guidance of the lower jaw in a particular position or in a particular movement towards the upper jaw). This is disadvantageous because a lower jaw position assumed by the subject may change during the time of registration of the jaw relation (active method). The lack of fixation or support of the lower jaw position with respect to the upper jaw regularly leads to deviations caused by random or unintentional movement of the subject's lower jaw, which makes an analog registration, e.g., with impression material, impossible.

Thus, the registration of the jaw relation using this device is only possible with the digital method. A further disadvantage is that the spatial position of the bite fork cannot be registered directly in the subject's mouth, and is thus the position of the registration device in relation to the upper jaw. The registration device is attached to an upper jaw bite fork, the spatial position of which in relation to the teeth must be determined. The upper jaw bite fork rests, with impression material in between, on the upper jaw tooth crowns.

To determine the spatial position of the bite fork in relation to the teeth, the bite fork must be removed from the subject's mouth and the entire impression-side portion of the bite fork including the positioning marker elements of the bite fork must be detected by scanner optics for superimposition with the scan of the tooth crowns. With this analog step of transferring the analog information of the upper tooth impression into digital data for superimposition with the digital data of the scan of the upper jaw tooth crowns, this system leaves the exclusively digital workflow, which is hereinafter also referred to as fully digital workflow, leading to errors which can later cause inaccuracies during the registration of the jaw relation.

DE 10 2010 021 934 A1 discloses a registration system for active, dynamic and digital detection of the jaw relation. A measuring unit positioned in the midface is adjusted in relation to the skull via a paraocclusal upper jaw bite fork with a measuring unit using electronic sensors, so that the jaw relation can be successfully registered with the measuring unit in the midface in relation to the skull after moving the measuring unit from the upper jaw paraocclusal bite fork to the lower jaw paraocclusal bite fork. The disadvantages here are that there is no possibility for an active, static and analog method for registering the jaw relation and that a third measuring unit in the midface is required.

The paraocclusal bite forks used in DE 10 2010 021 934 A1 are widely used and known in the field of dentistry. In principle, such bite forks are manufactured on individual jaw models in the dental laboratory and are time-consuming and costly. Paraocclusal bite forks that are easier to manufacture and thus save time and money are mechanically less resilient than laboratory-fabricated paraocclusal bite forks.

Intraoral scanners are increasingly common in dental practice. An intraoral scanner is, for example, known from DE 196 40 495 C2. Such scanners work with the photo-optical principle, wherein three-dimensional objects or motion sequences can be detected via repetitive photos from different perspectives, which are combined to form an overall spatial image.

Intraoral scanners are known which allow for both a static and a dynamic analog method for registering the jaw relation, which they make accessible for CAD/CAM technology via a predetermined file format, e.g., STL format. For registration, the scanner optics are laterally directed to the upper and lower jaw tooth rows, while the lower jaw performs movements (active or passive, digital, dynamic method). Due to the dimensions of the apparatus for intraoral use, the detection range of the scanner optics is limited to slightly more than one tooth crown width. This only allows for a registration of jaw relations in a very small range, in which the scanner optics can still detect sufficient upper and lower jaw tooth crown portions for registration, between the jaw relation in the final down bite, i.e., with maximum contact between the upper and the lower teeth, and the jaw relation with bite lock.

The intraoral scanner is currently the method of choice for registering the dental arch, i.e., all the crowns in a jaw. With this method, the examiner moves the detection range of the scanner over all of the subject's tooth crown surfaces and combines the individual scans, i.e. (digital) images or photos, to form a three-dimensional overall image—the image of the upper jaw or lower jaw dental arch, including the gingival and adjacent oral mucosa portions, if applicable.

This shows that there are already several means for registering jaw relation data, which are, however, limited in terms of feasible methods.

### BRIEF SUMMARY OF THE INVENTION

The object of the invention is to provide a device for registering jaw relations, which allows for a broad application, in particular for active and passive, for static and dynamic, and for analog and digital methods. It is also an object of the invention to provide an efficient method for registering jaw relation data using a device according to the invention.

The invention achieves the object by designing an above identified device such that the device for detecting jaw relation data of a person comprises a plurality of jaw relation elements, with a first elongated jaw relation element extending ventrally when used on a person and being configured for attachment to an upper jaw fitting element, in particular to an upper jaw bite fork or an impression tray or bite tray or a paraocclusal bite fork; a second elongated jaw relation element extending transversely in relation to the first jaw relation element and caudally; and a third elongated jaw relation element (8) extending transversely in relation to the second jaw relation element (7) and dorsally, wherein the second jaw relation element (7) is, in its direction of extension, movably connected to the first jaw relation element (6), and/or the third jaw relation element is, in its direction of extension, movably connected to the second jaw relation element such that the second or the third jaw relation element is configured to rest on at least one of an incisal or an occlusal surface of one or more lower jaw tooth crowns; and/or configured to be arranged close to the lower jaw tooth crowns such that it can be detected by a digital detection means together with the lower jaw tooth crowns.

In this context, the term “elongated” means that the direction of extension of the respective jaw relation element is, in its longitudinal direction, greater than in its width and/or thickness direction. The jaw relation element may extend in the longitudinal direction in a straight, wavy or curved manner. For example, the jaw relation element can, in the longitudinal direction, extend in a rod-shaped or strip-shaped manner. It may also have a winding or spiral shape. The jaw relation element may have a circular, oval, angular or polygonal cross-section.

Such a device has the advantage that it can be used for both active and passive as well as analog and digital methods for jaw relation registration, or for the registration of the tooth crowns of both jaws in relation to each other, respectively, thus providing a wide range of applications. Furthermore, the device according to the invention ensures a secure, tilt- and shake-free fit for applications in the entire jaw relation spectrum, i.e., the registration of all possible lower jaw positions. Furthermore, the device according to the invention is ready-made and thus no longer requires more time-consuming and costly work steps on jaw models or further, more complex work steps in a dental laboratory.

In times of digital work processes, it is also an economic advantage to work with only one widely used registration system. In the digital work process, intraoral scanners are essential for the registration of tooth crowns and are therefore also widely used. The device for registering jaw relation data according to the invention may also be used in combination with such intraoral scanners, thus allowing for particularly economical work by using the same scanners also for registering the jaw relations.

The object is further achieved by a method for detecting jaw relation data of a person according to the invention using the device according to the invention and a scanner, preferably an intraoral scanner, wherein at least one marking is provided on the upper jaw fitting element in the area bordering on the tooth crowns, and at least one marking is provided on each of the first to third jaw relation elements in the respective bordering area between them, which markings are detected by the scanner for unambiguous detection positions of the at least one jaw relation element for identifying jaw relation positions.

Should one or more incisal pins be provided, the incisal pins may also each have a marking to be detected by the scanner for unambiguous detection of positions of the one or more incisal pins for identifying jaw relation positions.

With the device according to the invention, a method for detecting jaw relation data can thus be applied by performing only two registration steps, namely a first registration step, in which a mandibular (joint) condyle center position is determined by a digital registration of the jaw relation by a rotational movement of the lower jaw, and a second step, in which the mandibular (joint) condyle center position is determined by a digital registration of the jaw relation by a protrusion of the lower jaw. It is no longer necessary to register all the different jaw relations with different protrusions of the lower jaw, which are required for manufacturing the aids, since the different jaw relations can be geometrically calculated from the mandibular joint path. The same steps may alternatively be performed with a lower jaw laterotrusion instead of a lower jaw protrusion. Likewise, it is conceivable to perform both a lower jaw protrusion and a lower jaw laterotrusion for registration.

Preferably, the method according to the invention comprises at least the following steps: (1) determining a first mandibular condyle center position by active digital registration of the lower jaw relation, wherein the lower jaw performs a rotational movement in the mandibular condyle center; (2) determining a first distance between the mandibular condyle center and a predetermined mesial point on the lower jaw; (3) determining a second distance between the predetermined mesial point on the lower jaw and a predetermined distal point on the lower jaw; (4) determining an angle between the first distance and the second distance; (5) determining the positions of the predetermined mesial point and the predetermined distal point by a lower jaw movement, preferably by a lower jaw protrusion or a lower jaw laterotrusion with the aid of a predetermined reference point on the lower jaw; (6) determining a second mandibular condyle center position with the aid of the first and second distances and the angle therebetween; and (7) determining a mandibular joint condyle path.

Here, the method steps (1) to (5) represent the first registration step, and the method steps (6) and (7) represent the second registration step.

Already known methods may for example proceed as follows: (1) generating a complete scan of the entire jaw relation elements and the upper jaw fitting element, (2a) generating a complete scan of the impressions of the intermediary impression material provided in the upper jaw fitting element together with the adjacent structures of the upper jaw fitting element, or (2b) generating a complete scan of the upper jaw fitting element and the tooth crown portions left out thereby, (3) generating a complete scan of the upper jaw tooth crowns and the lower jaw tooth crowns, and (4a) generating a scan in the bordering area between the third jaw relation element and/or at least one incisal pin, on the one hand, and lower jaw tooth crowns and/or lower jaw tooth crown portions, on the other hand, or (4b) generating a complete scan of the upper jaw fitting element and the lower jaw tooth crowns and/or the lower jaw tooth crown portions; wherein step (1) can be omitted when step (4b) is used.

The jaw relation is here determined by the respective digitally performed superimposition of the data sets of the digital scans. The method for superimposing the data sets (i.e., matching) to determine the position of two elements in relation to each other is commonly known and will thus not be further discussed here.

With these methods, the third jaw relation element and/or the incisal pin(s) do not need to rest directly against or on the lower jaw tooth crowns or portions of the lower jaw tooth crowns. They only need to rest directly against or on the lower jaw tooth crowns or portions of the lower jaw tooth crowns if the lower jaw needs to be passively fixed in a particular jaw relation or if a movement of the lower jaw needs to be passively guided over a particular jaw relation movement.

For selecting the bordering area, it must be ensured that both objects, i.e., the tooth crowns or the tooth crown portions, respectively, and the jaw relation element and/or the incisal pin, are detected by the scanner such that it is possible to determine the position of the two objects in relation to each other. For example, if the scanner has a large detection range and a high resolution, the bordering area can be selected correspondingly large. If the detection range is smaller and the resolution is lower, the bordering area must be selected correspondingly smaller.

It has proven helpful to provide markings, e.g., position markers, on the device to be able to reduce the effort of the scanning operations. Nevertheless, scans are still required in the bordering area of the fitting element, i.e., between the fitting element and tooth crowns and/or tooth crown portions, and/or between the fitting element and the impression material.

The method according to the invention using the device according to the invention can further reduce the scans in the bordering area and increase their evaluation accuracy. Furthermore, the method according to the invention is more efficient as it is reduced to only two registration steps, thus reducing time, data volume and/or computing power. Furthermore, the method according to the invention allows for an improved accuracy of the jaw relation data determination.

Advantageous designs and further developments, in particular of the device, are described in the dependent claims and explained below.

One advantageous embodiment provides that the first and/or the second and/or the third jaw relation element comprises, in its direction of extension, at least one marking, which is detectable by a detection means, preferably a scanner, more preferably an intraoral scanner, for unambiguous detection of positions of the jaw relation elements for identifying jaw relation positions. Alternatively, the detection means may also be the human eye.

It is advantageous if the markings are arranged at intersection points of the jaw relation elements for detecting their relative position to each other. This arrangement makes it possible to apply an efficient method for detecting jaw relation data.

Markings configured for analog and/or digital detection are particularly suitable. This makes the device versatile and applicable for different methods.

Another possibility is that the upper jaw fitting element of the device comprises at least one marking at or in the area bordering on cut-outs for digital machine detection of its position in relation to the tooth crowns in the upper jaw.

Thus, the device may further comprise a first incisal pin extending transversely in relation to the second or the third jaw relation element and caudally and being movably connected to the second or third jaw relation element in the direction of extension thereof, the first incisal pin being configured for being dorsally or ventrally placed on at least one lower jaw tooth crown. As a result, it is possible to fix the degree of fixation with which the lower jaw is to be positioned in relation to the upper jaw in a particular jaw relation. In particular, the incisal pin may be configured such that its shape approximates the shape of the lower jaw tooth crown. To this end, the incisal pin may, for example, have a slightly curved, in the labial direction, i.e., towards the lips, convex shape. Furthermore, to further increase the degree of fixation between the incisal pin and the lower jaw tooth crown, impression material may be provided, which virtually prevents a relative movement between the incisal pin and the lower jaw tooth crown.

The device may further comprise a second incisal pin extending transversely in relation to the second or the third jaw relation element and caudally and being movably connected to the second or third jaw relation element in the direction of extension thereof, the second incisal pin being arranged opposite the first incisal pin for contact with or spaced apart from the at least one lower jaw tooth crown. This incisal pin may also be formed such that its shape approximates the shape of the lower jaw tooth crown.

If only one incisal pin is provided, it can either labially or lingually rest against the lower jaw tooth crown. If two incisal pins are provided, they are usually arranged such that one rests labially and one rests lingually against the same lower jaw tooth crown. It is possible that only one of the two incisal pins is arranged movably with respect to the third jaw relation element, while the other of the two incisal pins is fixed on the third jaw relation element in a predetermined position.

It is also conceivable that instead of two separate incisal pins, one single incisal pin is provided, which is U-shaped and has its opening facing the lower jaw tooth crown, thus having a first leg arranged labially to the lower jaw tooth crown and a second leg arranged opposite the first leg and lingually to the lower jaw tooth crown. Also in this case, it is conceivable that the incisal pin, with impression material in between, rests against the lower jaw tooth crown in order to reduce the (undesirable) relative movement between the incisal pin and the lower jaw tooth crown.

For digital registration, it is advantageous if the first incisal pin and/or the second incisal pin each comprise, in their direction of extension, at least one marking (200), which is detectable by a detection means, preferably a scanner, more preferably an intraoral scanner, for unambiguous detection of positions of the incisal pins for identifying jaw relation positions. Alternatively, the detection means may also be the human eye.

It is advantageous if the markings are arranged at intersection points of the incisal pins and/or at intersection points between an incisal pin and/or both incisal pins and the second jaw relation element or the third jaw relation element, in order to detect their positions in relation to each other. This arrangement allows for the application of an efficient method for detecting jaw relation data.

Markings configured for analog and/or digital detection are particularly suitable. This makes the device versatile and applicable for different methods.

In one possible embodiment of the device, at least one jaw relation element may comprise a dorsal section and a ventral section connected to each other by an articulated joint. These allow for free laterotrusive movements of the lower jaw according to the free choice of the subject, or predetermined laterotrusive movements guided according to the desired destination, without causing the undesired relative movement between the lower jaw tooth crown and the third jaw relation element or the incisal pin(s), respectively.

For this purpose, the articulated joint may be adapted such that the distal section of the at least one jaw relation element can be moved in at least three degrees of freedom, in particular in the three translational motion directions “up-down”, “front-back” and “right-left”. The three degrees of freedom allow for the distal section to be movable in the dorsal-ventral direction (anterior-posterior direction, “front-back”), in the caudal-cranial direction (opening or closing direction, “up-down”) and in the lateral direction (“right-left” direction), as well as in combined directions, i.e., directions resulting from a superposition of at least two of said directions. This may, for example, be implemented by means of a ball-and-socket joint or a hinged joint connection.

A conceivable further development of the device may provide that the dorsal portion of the third jaw relation element extends further in the dorsal and lateral direction along the lower jaw tooth crowns and rests against and/or on and/or close to the occlusal surfaces of the lower jaw tooth crowns and/or completely or partially covers them, and/or rests completely or partially on the occlusal surfaces, with impression material in between, and/or is reversibly connected thereto. Such third jaw relation element rests on several tooth crowns and has thus a more stable position, i.e., it cannot move so easily when the lower jaw is moved. Furthermore, with such a design, in particular using impression material, when detecting the jaw relation data, it is possible to create an impression of the lower jaw by means of which the particular three-dimensional surface data can be identified. In case of mechanical detection, for example, by an intraoral scanner, the registration accuracy is increased by this design of the third jaw relation element. When the third jaw relation element is supported in the incisal area, a scan can only be performed between the third jaw relation element and the incisors of the lower jaw, whereas with the extended third jaw relation element on the lower jaw dental arch, a scan can be performed on both sides in the posterior tooth area between these tooth crowns and the extended third jaw relation element.

In one exemplary embodiment, the device may further comprise an upper jaw fitting element adapted as a dental arch-shaped upper jaw bite fork having, at least at the open end sections, receiving areas configured to reversibly receive, in particular with the aid of impression material, upper jaw tooth crowns in a manner to be stable during manipulation, and being, in the area of the vertex of the arch, fixed to the first jaw relation element. “Fixed” can here mean a releasable (reversible) or a non-releasable (irreversible) connection.

The upper jaw bite fork rests, with impression material in between, partially on and/or against and/or close to the upper teeth, or the upper teeth and the adjacent gingiva of the alveolar process.

In one possible embodiment, the receiving areas of the upper jaw bite fork may leave out an area of the anterior tooth crowns, in particular of the incisor crowns. In further possible embodiments, the receiving areas of the upper jaw bite fork may also leave out other or further tooth crowns and/or tooth crown portions arranged distally to the anterior tooth crowns. This means that the left-out cut-outs are also, exclusively or additionally, formed on other or further tooth crowns or tooth crown portions than on the anterior tooth crowns, and that the cut-outs are continued until, finally, only the (partial) circumferences of all or part of the tooth crowns of the dental arch with adjacent gingiva are covered.

In contrast to known paraocclusal bite forks, which rest against the dental arch on the outer side of the tooth crowns and against the areas between the tooth crowns, i.e., the interdental area, at their largest circumference by means of clamping fit, the upper jaw bite fork according to the invention, rests, with impression material in between, completely or at least partially, on and/or against and/or close to the tooth crowns and the adjacent gingiva of the alveolar process.

In particular, the upper jaw bite fork can be inserted ready-made in the common bite fork sizes known in the field of dentistry. The upper jaw bite fork can thus already be fixed to the upper jaw, with impression material in between, during the first appointment with the subject, whereas the known, individual, not-ready-made paraocclusal bite forks, which have to be manufactured in the laboratory, are manufactured in the laboratory after taking an impression of the upper teeth during a first appointment with the subject and can only in a second session be fixed to the upper jaw. Furthermore, with the upper jaw bite fork, the three-dimensional surfaces can be known and do not have to be gathered again for each application.

Leaving out part of or all of the upper jaw anterior tooth crowns and, if applicable, also the upper jaw canine tooth crowns can make it easier for the examiner to position the lower jaw, i.e., to adjust the lower jaw in relation to the upper jaw in a particular relation to each other, as they can use the incisal edges and the upper jaw anterior tooth portions, and, if applicable, canine tooth portions, adjacent thereto, that are left out by the bite fork and the impression material, for orientation, which is particularly advantageous for the passive method. When registering the jaw relation by means of optical or ultrasonic scans, e.g., by a commercially available optical intraoral scanner, the cut-outs allow for the positioning of the upper jaw bite fork in relation to the upper teeth to be carried out via the optical scan on the basis of the exposed tooth crown portions. The detection by an optical scanner is enhanced by the cut-outs in the anterior tooth area and the rearmost posterior tooth area, because the angular reference between the bite fork, on the one hand, and the dental arch, on the other hand, becomes more precise due to the maximum distance between the measuring points.

Furthermore, leaving out the longest crowns in the dental arch, namely the anterior tooth crowns and, if applicable, also the canine tooth crowns, is particularly advantageous because the bite is locked to a lesser extent, i.e., the distance between the upper jaw tooth crowns and the lower jaw tooth crowns can be smaller than it would be without leaving out these teeth. The anterior tooth crowns may also be referred to as incisor tooth crowns. This allows to position the lower jaw with a smaller occlusal distance between the upper and lower teeth, which may also be referred to as interocclusal distance or bite lock, than would be possible if these tooth crowns were completely covered, as in the case of impression trays, for example. This is because the incisal edges of the anterior teeth and, if applicable, the canine teeth generally project beyond the occlusal plane of the remaining teeth. The reduced bite lock allows for the use of the device for active and passive, static and dynamic jaw relation registration, or for relation registration of the tooth crowns of both jaws in relation to each other, for manufacturing splints or occlusal appliances which, when inserted into the mouth of the subject, have a greater than or the same bite lock as the device. This is because splints and occlusal appliances rest on at least all tooth crowns in a jaw, in case of mandibular advancement splints (UPS) also on at least all lower jaw tooth crowns and additionally partially on all upper jaw tooth crowns, wherein the bite lock is greater than or equal to that when using the upper jaw bite fork of the device according to the invention. The difference or equality, respectively, of these two bite locks makes it possible to position a jaw relation element between the two incisal edges of the upper and lower incisors such that it can rest on the incisal edges of the lower incisor tooth crowns. Splints, occlusal appliances and/or mandibular advancement splints are hereinafter referred to as aids.

The positioning of the jaw relation is achieved by connecting the third jaw relation element, via further elements, in particular the first and the second jaw relation element, to the upper jaw bite fork, which rests, with impression material in between, on the upper jaw tooth crowns, and/or the upper jaw tooth crowns and the adjacent gingiva, and the digital registration of the jaw relation is achieved by detecting the positions of the upper jaw bite fork in relation to the upper jaw tooth crowns, all further portions of the device in relation to each other (thus also to the upper jaw bite fork) and to the incisal edges, or further partial areas of the lower jaw tooth crowns by scanning, e.g., by an optical intraoral scanner, and feeding them to the CAD/CAM programs for manufacturing the aids.

One possible embodiment of the device may herein provide that the upper jaw bite fork and the first jaw relation element are integrally formed, i.e., formed in one piece.

In the device, the receiving areas on the side facing the upper jaw tooth crowns in the inserted state can each have an indentation or a recess. These can improve the reception of the impression medium, which makes taking the impression more comfortable for the subject.

Furthermore, the receiving areas may have plurality of small through-holes on their circumferential surface. These small through-holes may also be referred to as perforations and serve to improve the retention, i.e., the reversible, mechanical connection, of the impression material on the upper jaw bite fork.

In addition to the static or dynamic digital method, the static analog method with impression material and analog manufacturing in the dental laboratory, or a combination of both—the analog and the digital—method with the device according to the invention is also an option.

### BRIEF DESCRIPTION OF THE DRAWINGS

The invention is described in more detail below with reference to the drawings. The drawings are to be understood as merely exemplary. They are schematic, not drawn to scale, and each only show the features essential for understanding the present invention. It will be appreciated that there may be further features, as familiar to a person skilled in the art. In the drawings, the same reference numerals designate the same or corresponding elements. In the drawings:

FIG. 1 shows a side view of a human skull with a lower jaw in a habitual lower jaw opening position and with a device according to the invention in a first exemplary embodiment;

FIG. 2 shows a front view of FIG. 1;

FIG. 3 shows a side view of the human skull with the lower jaw in the habitual lower jaw opening position and with the device according to the invention in a second exemplary embodiment;

FIG. 4 shows the side view of FIG. 3, with the lower jaw in lower jaw protrusion;

FIG. 5 shows a side view of the human skull with the lower jaw in the habitual lower jaw opening position and with a plotted sagittal habitual lower jaw opening path and a plotted range of border movements for an incisal point in the sagittal plane;

FIG. 6 shows a front view of FIG. 5, with the plotted border movements for the incisal point in front view;

FIG. 7A shows an incisal pin, located ventrally (anterior) to the lower jaw tooth crowns, fixed to a jaw relation element, which is connected to another jaw relation element, in a side view;

FIG. 7B shows an incisal pin, located dorsally (posterior) to the lower jaw tooth crowns, fixed to a jaw relation element, which is connected to another jaw relation element, in a side view;

FIG. 7C shows the incisal pin, located ventrally to the lower jaw tooth crowns, fixed to the one jaw relation element comprising an occlusal support, with an articulated connection between the incisal pin and the one jaw relation element and an articulated connection within the one jaw relation element;

FIG. 7D shows a plan view of FIG. 7C, additionally with the lower jaw dental arch;

FIGS. 7E and 7F show plan views of FIG. 7C, with the one jaw relation element and the incisal pin having their articulated connections set to the right for guiding the incisal point from the habitual lower jaw opening position into a laterotrusive position without causing a retrusion of the dental arch;

FIG. 8 a shows plan view of the upper jaw bite fork with an integrally formed first jaw relation element;

FIG. 9A shows an exploded view of the device according to the invention in the first embodiment with the upper jaw bite fork;

FIG. 9B shows an exploded view of one possible embodiment of the device according to the invention with an alternatively adapted upper jaw bite fork portion;

FIG. 10 shows an illustration of an upper jaw dental arch and a lower jaw dental arch to illustrate the dental scheme;

FIG. 11 shows an illustration of a first registration step of a method according to the invention; and

FIG. 12 shows an illustration of a second registration step of the method according to the invention.

### DETAILED DESCRIPTION OF THE INVENTION

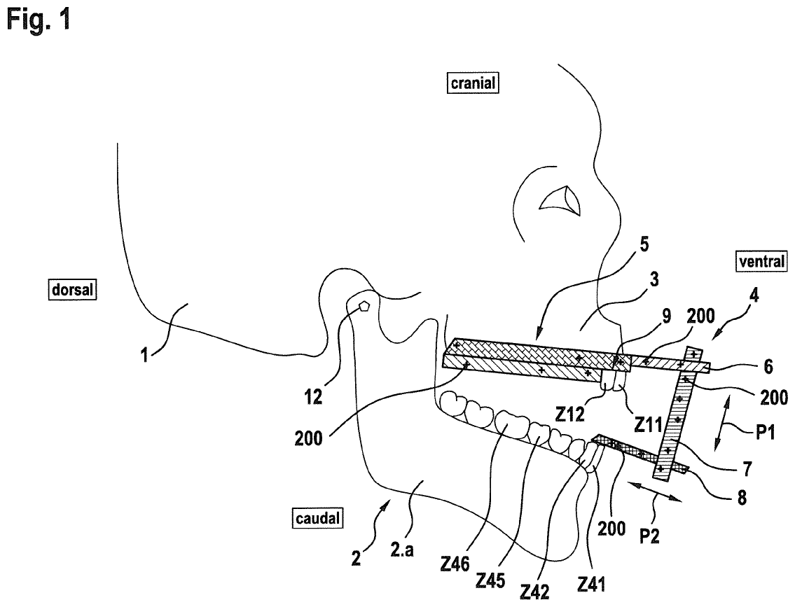

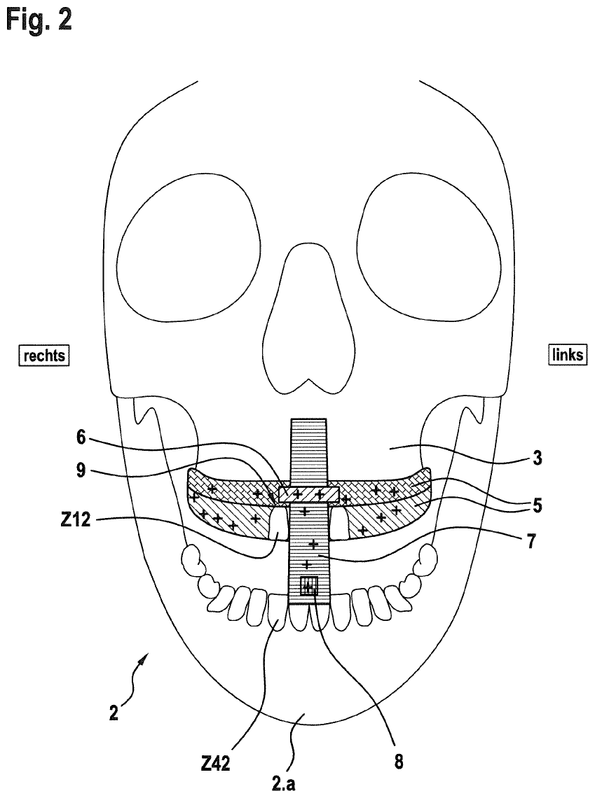

FIG. 1 and FIG. 2 show a side view and a front view, respectively, of a human skull 1 with a lower jaw 2 in a habitual lower jaw opening position 2.a predetermined in relation to an upper jaw 3, wherein a device 4 for registering jaw relation data in a first exemplary embodiment is arranged on the upper jaw 3. The device 4 is arranged on an upper jaw bite fork 5, which is an exemplary embodiment for an upper jaw fitting element, and comprises a first jaw relation element 6 extending forward, i.e. extending in the ventral direction; a second jaw relation element 7 extending downward, i.e. extending in the caudal direction, from the first jaw relation element 6; and a third jaw relation element 8 extending rearward, i.e. extending in the dorsal direction, from the second jaw relation element 7.

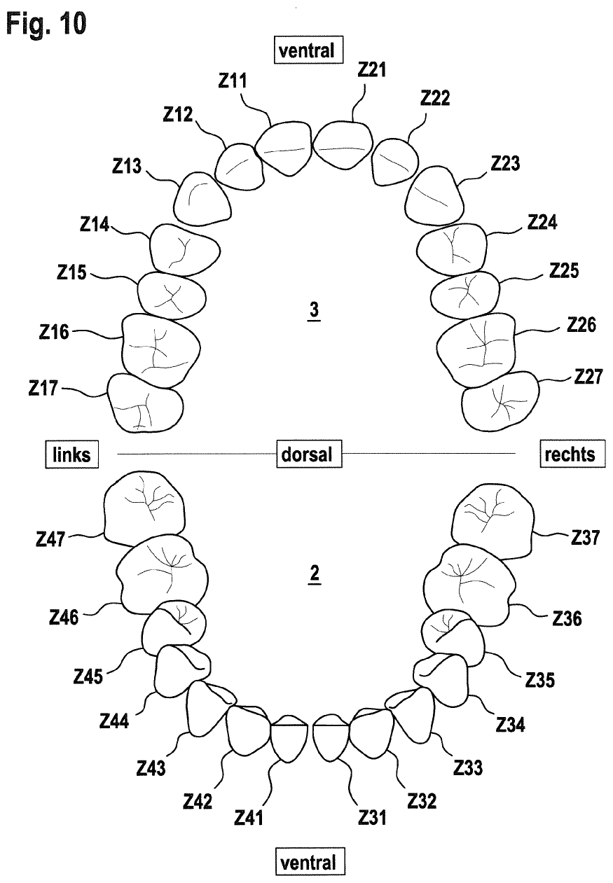

Together with the upper jaw bite fork 5, the device 4 provides a static lower jaw opening position in the habitual lower jaw opening position 2.a selected as an example, i.e., a support of the lower jaw 2 with respect to the upper jaw 3 (passive method) as an aid to help a human subject hold this lower jaw opening position 2.a. This is possible because the individual elements of the device 4 extending forward from the upper jaw bite fork 5 can be movably adjusted and locked in relation to one another. In the exemplary embodiment shown here, the second jaw relation element 7 is, in its direction of extension, movably connected to the first jaw relation element 6 (see arrow P1) and arranged transversely to the first jaw relation element 6, and the third jaw relation element 8 is, in its direction of extension, movably connected to the second jaw relation element 7 (see arrow P2) and arranged transversely to the second jaw relation element 7. Furthermore, the third jaw relation element 8 rests on the incisal edge, i.e. the cutting edge, of one or more of the first lower incisors Z32 to Z42 (see FIG. 10).

A cut-out 9 in the area of in the upper incisors Z12 to Z21, or in the area of the upper incisors and canine teeth Z13 to Z23, can reduce a bite lock caused by the upper jaw bite fork 5, as described above. If the teeth Z12 to Z21 or Z13 to Z23, which are the longest, were also covered by the upper jaw bite fork 5, the bite lock would be larger and reduce the variations of the jaw relations adjustable by the device.

Therefore, the use of this device is particularly suitable for the registration of a particular active lower jaw protrusion for manufacturing mandibular advancement splints (UPS) for the treatment of snoring or nocturnal obstructive respiratory disorders. The UPS are splint systems that rest against the upper jaw tooth crowns and lower jaw tooth crowns, thereby causing an equal or larger bite lock, even when the anterior tooth crowns or the anterior and canine tooth crowns are left out, than when inserting the device 4 with the upper jaw bite fork 5. The device 4 in combination with the upper jaw bite fork 5 may hereinafter also be referred to as means 45. This difference in bite lock between using a UPS and using means 5 leaves at least one such gap between the upper jaw incisal edges and lower jaw incisal edges free for the device 4, through which the third jaw relation element 8 can rest on the incisal edges of the lower incisors Z32 to Z42 and bring the lower jaw 2 into position.

Likewise, the use of this device is suitable for manufacturing splints that rest on the upper jaw or the lower jaw in all crown areas, i.e., including all anterior tooth crowns of the corresponding jaw. Such splints are used, for example, in the therapy for temporomandibular joints, jaw musculature, tooth misalignments and jaw fractures.

Markings 200, e.g., optical markers, (shown as crosses in FIG. 1) arranged on the surfaces of the upper jaw bite fork 5 and the device 4 serve to render scanning methods, e.g., by means of optical intraoral scanners, more accurate and/or serve as an electronic measuring system formed as a transmitter/receiver system 200 for metrological determination of the jaw relation, which will be discussed later.

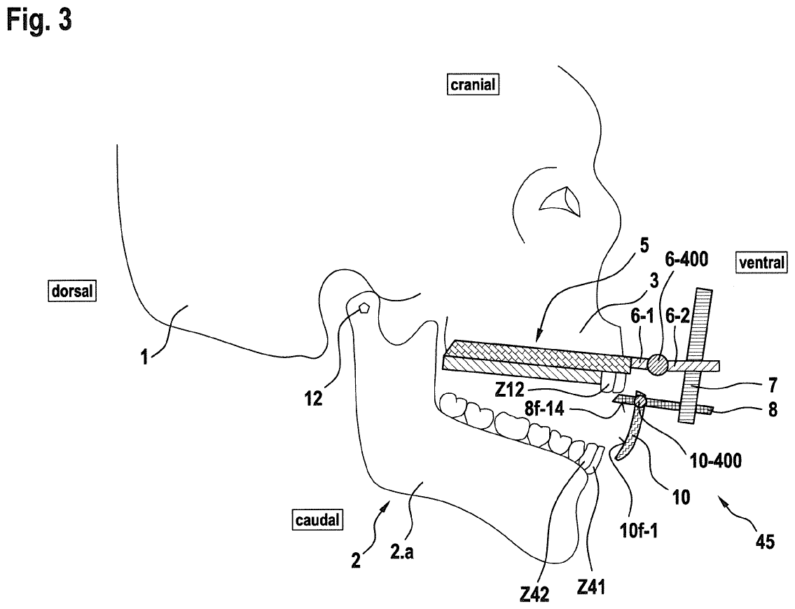

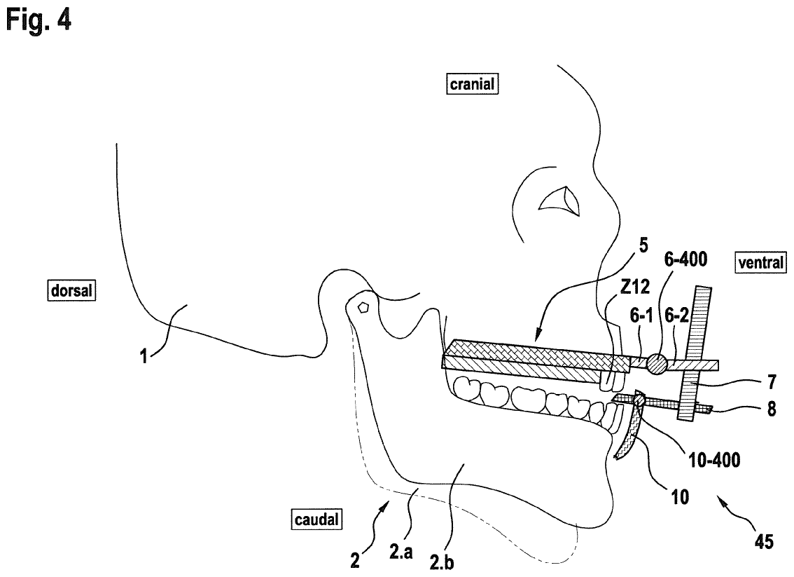

FIGS. 3 and 4 show a second exemplary embodiment of the device 4, which is particularly suitable for the dynamic method for jaw relation registration, wherein FIG. 3 shows the lower jaw 2 in the habitual lower jaw opening position 2.a and FIG. 4 shows the lower jaw 2 in a possible exemplary lower jaw protrusion 2.b, e.g., a (predetermined) jaw relation for the treatment of sleep apnea and/or snoring, or a (predetermined) jaw relation for the treatment of temporomandibular joint disorders.

In case of dynamic jaw relation registrations of a larger extent, in which the detection range of, e.g. optical intraoral scanners, of device portions, in particular the third jaw relation element 8, and lower jaw tooth crown portions is exceeded, thus making a jaw relation determination impossible, a first incisal pin 10, as a caudal elongation of the third jaw relation element 8 located ventrally to the lower jaw tooth crowns, is helpful for bridging the exceeded detection range of the intraoral scanner, so that the incisal pin 10 and the adjacent portions of the lower jaw tooth crowns Z42 and Z41 remain for the purpose of registration within the detection range of the intraoral scanner over the entire closing movement of the lower jaw from e.g., the habitual lower jaw opening position 2.a (see FIG. 3) to, e.g., the desired lower jaw protrusion 2.b (see FIG. 4), as well as in the reverse direction of movement of the lower jaw 2.

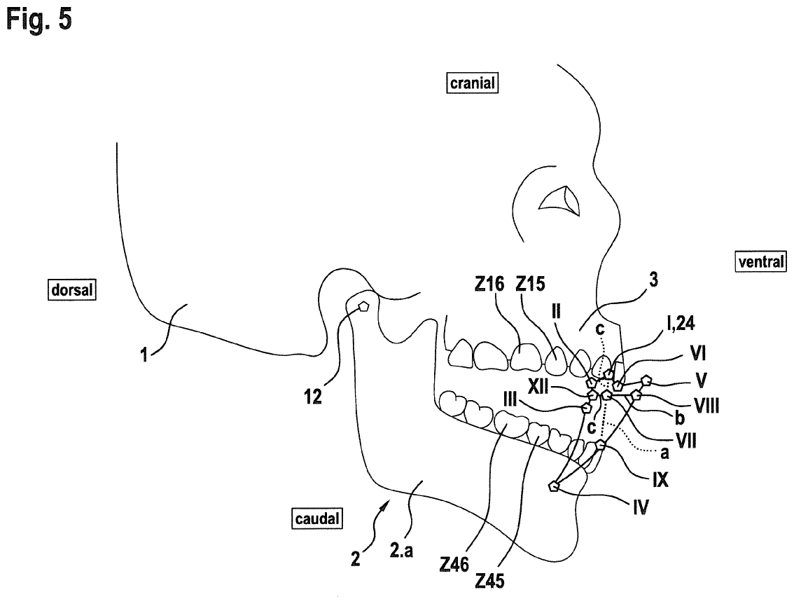

For this purpose, it is advantageous if the incisal pin 10 is ready-made in several embodiments typical of the lower jaw movement according to average values. In the embodiment shown here, the first jaw relation element 6 is divided into a dorsal area 6-1 and a ventral area 6-2 with a ball-and-socket joint connection 6-400, which is helpful for aligning the device 4 and can be seen in FIG. 5.

FIG. 5 shows the range of motion of the lower jaw 2 in relation to the upper jaw 3 for an incisal point 24 in the sagittal plane. The incisal point 24, and thus the anterior tooth crowns of the lower jaw 2, are able to be moved within the sagittal plane, marked with straight connecting lines I to VI.

Other than this, in case of using single splints (hereinafter referred to as splints) or double splint systems (e.g. mandibular advancement devices, so called UPS), the range of motion of the incisal point 24 is, due to the bite lock described above, only possible within the sagittal area, marked with straight connecting lines between points XII, III, IV, IX, VIII, VII, XII, whereas the range of motion between points XII, II, I, VI, V, VIII, VII, XII is blocked by the bite lock. The third jaw relation element 8 thus fits into the intermediate space between b (distance between points VII and VIII, desired or selected protrusion plane) and/or c (distance between XII and VII) and point VI (incisal edge of the upper central incisor crowns) when means 45 is inserted, since means 45 blocks the bite to an equal or lesser extent than the splints or double splint systems.

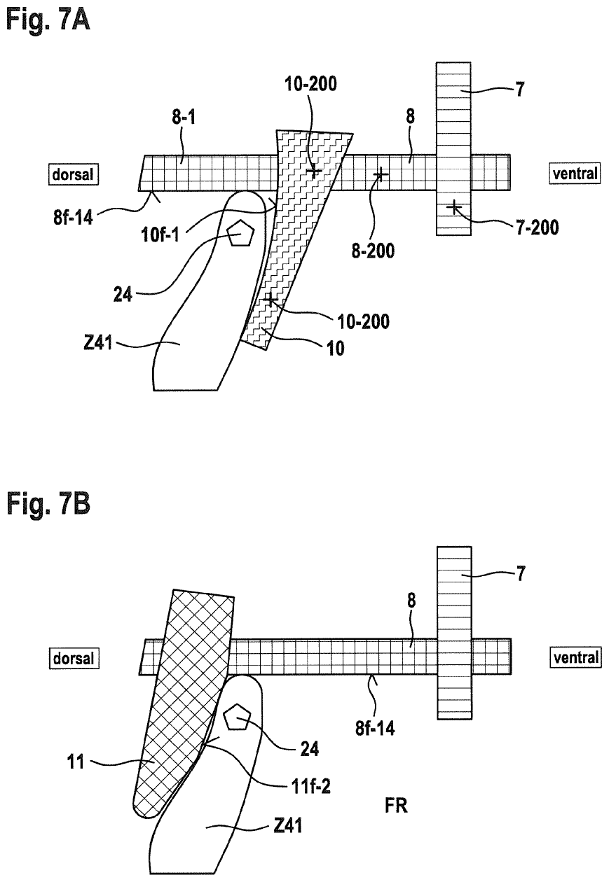

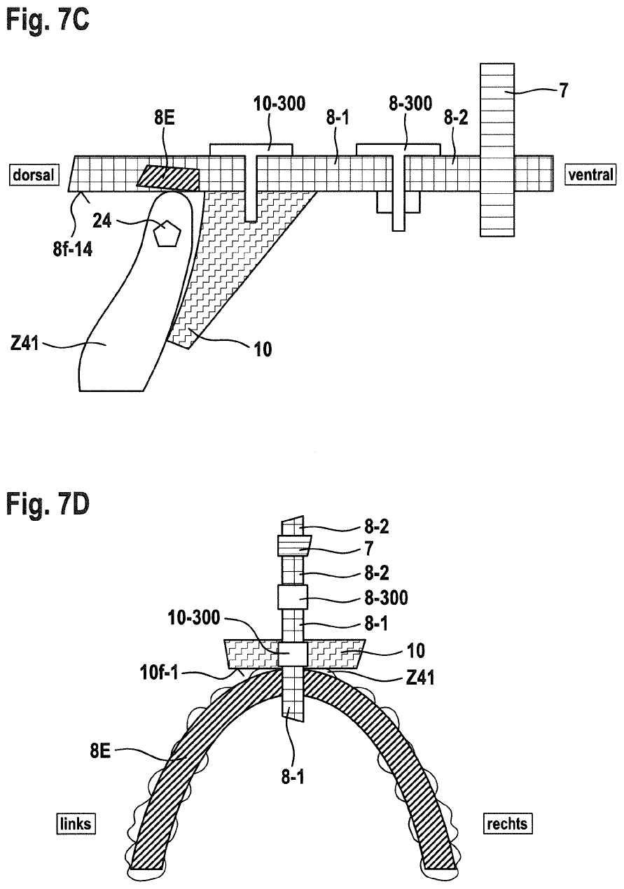

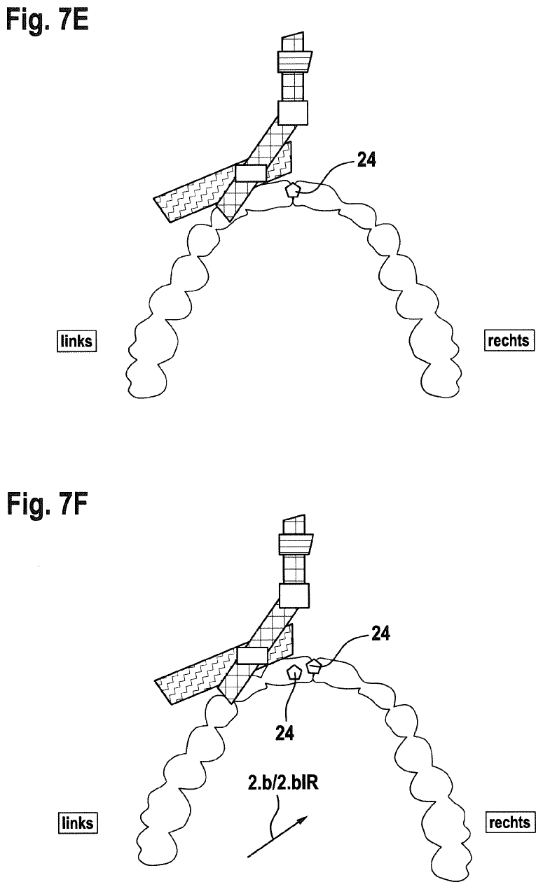

The alignment of the dorsal surface 10f-1 (see FIG. 7) of the incisal pin 10 by means of an articulated joint 10-400 adapted as a ball-and-socket joint (see FIG. 3 and FIG. 4) and/or the individual manufacturing and/or the ready-made manufacturing of the dorsal surface 10f-1 of the incisal pin 10 is based on the path of the incisal point 24 from, e.g., the habitual lower jaw opening position IX to, e.g., the selected lower jaw protrusion position to a point on the distance b or c, which is of particular advantage for manufacturing UPS, so that the incisal pin 10, together with the anterior tooth crown portions of the lower jaw, remains constantly within the detection range of the intraoral scanner during this movement of the lower jaw. The horizontal orientation of the third jaw relation element 8 is, for example, based on the extension of the appropriate protrusion plane b, so that an unaltered bite lock between b and VI can be achieved for different lower jaw protrusion positions, which is of particular advantage for manufacturing UPS.

Such specifications regarding the orientation are always based on the purpose the dental aids are to achieve.

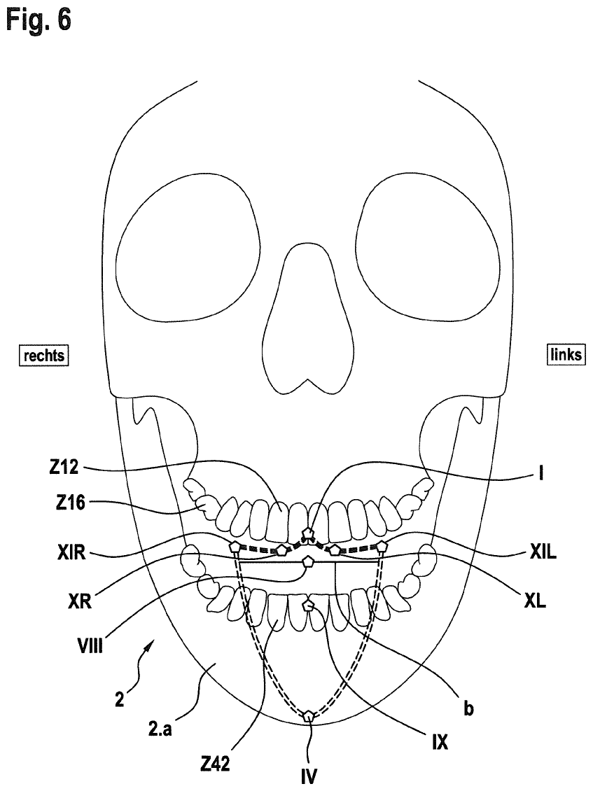

FIG. 6 shows, in a frontal view of FIG. 2, the incisal positions I (final bite), IX (maximum habitual mouth opening) and IV (maximum possible active mouth opening) for the incisal point 24. During the lateral border movements, also referred to as laterotrusive movements, shown in FIG. 6, the lower jaw 2 is guided from position I over the anterior teeth of the upper jaw 3 to the right into position XR and to the left into position XL, and from here over the canine teeth to the left into position XIL and to the right into position XIR, from where, after maximum opening of the lower jaw on both sides, it reaches the central position IV, the maximum possible active mouth opening (maximum active lower jaw opening position). The dashed line shows the range of motion of the incisal point 24 of the lower jaw 2, visible in frontal view.

Other than this, when using splints or double splint systems (e.g., UPS), the range of motion of the incisal point 24 is, due to the bite lock described above, blocked in this range of motion between the straight connection line b and the upper portion of the range of motion shown by the dashed line. The third jaw relation element 8 (see also FIGS. 1 to 4) fits into the intermediate space caused by this blocked range of motion, so that static and dynamic jaw relation registrations for such dental aids can be achieved.

Consequently, all static and dynamic jaw relation registrations in the remaining portion of the range of motion, below the straight distance b, can be performed with the device 4, in particular in combination with the upper jaw bite fork 5.

FIG. 7A shows the third jaw relation element 8 with the incisal pin 10, however, shown in a shortened manner, wherein the ventral tooth crown surface of tooth Z41 rests against the dorsal surface 10f-1 of the incisal pin 10, and the bottom surface 8f-14 of the distal portion 8-1 of the third jaw relation element rests on the incisal edge, and FIG. 7B shows the third jaw relation element 8 with a second incisal pin 11, wherein the dorsal tooth crown surface of tooth Z41 rests against the ventral surface 11 f-2 of the incisal pin 11 and the bottom surface 8f-14 of the third jaw relation element 8 rests on the incisal edge. The use of at least one incisal pin 10, 11 increases the degree of fixation with which the lower jaw 2 is to be positioned in a particular jaw relation relative to the upper jaw 3 compared to the degree of fixation which would be possible with the third jaw relation element 8 alone.

This degree of fixation can be further increased by positioning the incisal pins 10, 11 together on the third jaw relation element 8 such that both the ventral and the dorsal crown surfaces, together with the incisal edge of the tooth crown (here: tooth Z41), get to the rest between the incisal pins 10, 11 and the third jaw relation element 8. In addition, the degree of fixation can be further increased by providing impression material between the two incisal pins 10, 11 and the bottom surface 8f-14 of the third jaw relation element.

Since the incisal tooth crowns of different subjects may have different dimensions, the incisal pins 10, 11, or just one of them, may be connected to the third jaw relation element 8 such as to be moveable in the sagittal direction and thus be adjusted according to the tooth crown dimensions, if applicable, with the possibility of further adjustment by means of one or both ball-and-socket joints of FIGS. 3 and 4.

The advantage of the increase in the degree of fixation as described above is accompanied by a decrease in the laterotrusive movements of the lower jaw 2. While this is still possible without restriction when using only the third jaw relation element 8 without incisal pins 10, 11, it is almost completely inhibited when using both incisal pins 10, 11.

When using the incisal pin 10 of FIG. 7A, laterotrusions of the lower jaw are neither freely possible nor completely inhibited, but only possible insofar as permitted by this incisal pin 10 with its guide surface 10f-1 for this movement.

FIGS. 7C to 7F show a possible further development of the embodiments of the device 4 shown in FIGS. 1 to 4, which allows for the previously addressed restricted or even inhibited laterotrusive movements for the active and passive methods in a manner desired by the examiner.

FIG. 7C shows the jaw relation elements 7 and 8 with an occlusal extension 8E and the incisal pin 10, wherein a hinge-joint connection 10-300 or 8-300 is provided between the incisal pin 10 and the third jaw relation element 8 or between the distal portion 8-1 and the ventral portion 8-2 of the third jaw relation element 8, respectively.

With the hinge-joint connections 10-300 and 8-300, the surface 10f-1 is, with respect to the tooth crowns of the dental arch, set such as to allow for free laterotrusive movements according to the subject's free choice and/or to guide predetermined laterotrusive movements according to the respective purpose.

FIGS. 7D to 7F illustrate this in a plan view of FIG. 7C, wherein in FIG. 7D, the setting of the incisal pin 10 and the third jaw relation element 8 corresponds to that in FIG. 7C, and the occlusal extension 8E is shown. In contrast, in FIGS. 7E and 7F, the dorsal portion 8-1 is angled clockwise and the incisal pin 10 is angled or rotated counterclockwise, so that the lower jaw 2 is guided into the laterotrusive movement in the ventral direction and to the right (2.b/2.bIR) with the ventral crown surfaces of the teeth Z31, Z32 of its dental arch (teeth Z37 to Z47) sliding along the dorsal surface 10f-1 of the incisal pin 10 and with its incisal edges of the crowns Z31, Z32 sliding along the caudal surface 8f-14 of the third jaw relation element 8. For this purpose, the laterotrusive movement 2.b/2.bIR shown in FIG. 7F is set by the device 4 such that the entire predominant rotation with small laterotrusion of the one mandibular condyle center 12.a, which corresponds to the right mandibular condyle center in FIG. 1, causes no retrusion of the dental arch located on this side. Such setting of the device is exemplary and must be appropriately adapted to the correspondingly required application conditions.

Such setting of the incisal pin 10, 11 for particular laterotrusive movements is useful for the active and/or passive static and the active and/or passive dynamic jaw relation registration of laterotrusive movements for manufacturing e.g., UPS, in order to allow for laterotrusive movements when the UPS is inserted in the subject's mouth, wherein the one side of the lower jaw 2 (see FIG. 2: right side of the skull 1, shown on the left) does, during a laterotrusive movement towards this side (i.e. here towards the right side and thus to the left in FIG. 2), not slide into a backward movement, which would counteract the desired effect of the protrusion of the UPS. In mirror-inverted view, this also applies to the other side of the lower jaw (i.e., here the left side).

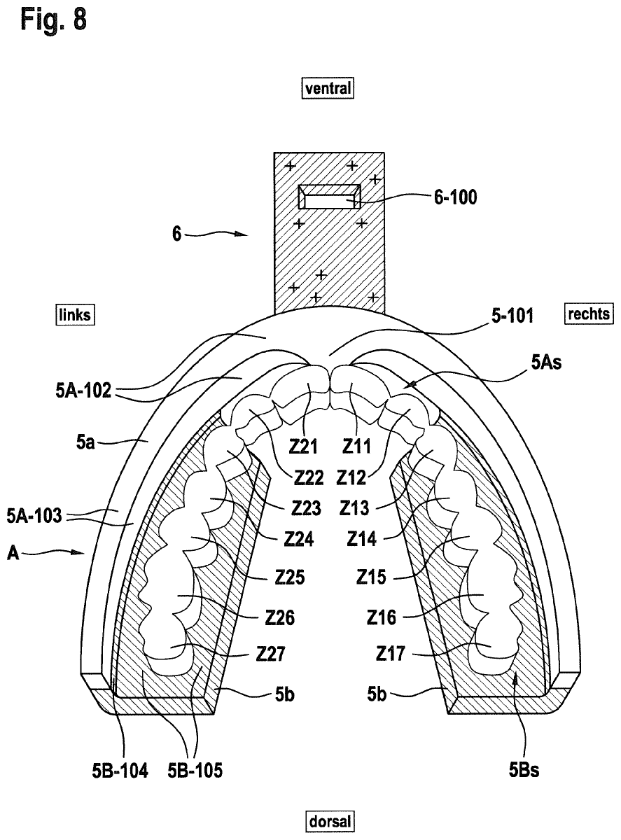

FIG. 8 shows a plan view of the upper jaw bite fork 5 with the first jaw relation element 6 of FIGS. 1 to 4. In the area of the anterior teeth Z12 to Z22, or, in case of a lower jaw bite fork, in the area of the anterior teeth Z31 to Z42, respectively (the latter are not shown in FIG. 8), the anterior circular portion 5A-102 of the upper jaw bite fork 5 extends, separated from the tooth crowns by a gap 5As, and labially to these tooth crowns and above, i.e. cranially to, their incisal edges in the upper jaw 3 (FIG. 8) and below, i.e. caudally to, their incisal edges in the lower jaw 2 (not shown). The gap width of 5As in the area of teeth Z11 and Z21 in the upper jaw 3 (FIG. 8) and in the area of teeth Z31 and Z41 in the lower jaw 2 is predetermined by the interdental pin 5-101, which is formed as a dorsal extension on the inner side of 5A-102 with its tip arranged approximally or, if applicable, interdentally between Z11 and Z21 or Z31 and Z41, respectively. The interdental pin 5-101 thus prevents the device 4 from tilting. The anterior circular upper jaw bite fork portion 5A-102 in the area of the anterior teeth continues to extend rearward, i.e. dorsally, in the canine and posterior tooth area Z13 to Z17 and Z23 to Z27 in the upper jaw 3, or Z33 to Z37 and Z43 to Z47 in the lower jaw 2, respectively, with its gap 5As, as the posterior circular upper jaw bite fork portion 5A-103 and extends here on the labial or buccal side of the tooth crown surfaces until below their occlusal surfaces. This posterior circular upper jaw bite fork portion 5A-103 with the gap 5As continues to extend downward, i.e., caudally, in the upper jaw 3 and upward, i.e., cranially, in the lower jaw 2, respectively, into the interrupted upper jaw bite fork portion 5B-104 with a gap 5Bs until the upper jaw bite fork portion merges into a horizontally extending portion 5B-105 to rest against, on or close to the occlusal surfaces of these teeth. The width and length of the upper jaw bite fork 5 must be matched to the width and length of the dental arch of the respective subject and/or be selected according to the internationally known standard sizes for impression trays.

The upper jaw bite fork part 5A is guided into the vestibule, i.e., the oral cavity, to such an extent that the upper jaw bite fork 5 is sufficiently fixed by bearing, with impression material in between, on the teeth, or both on the teeth and the gingiva of the alveolar process.

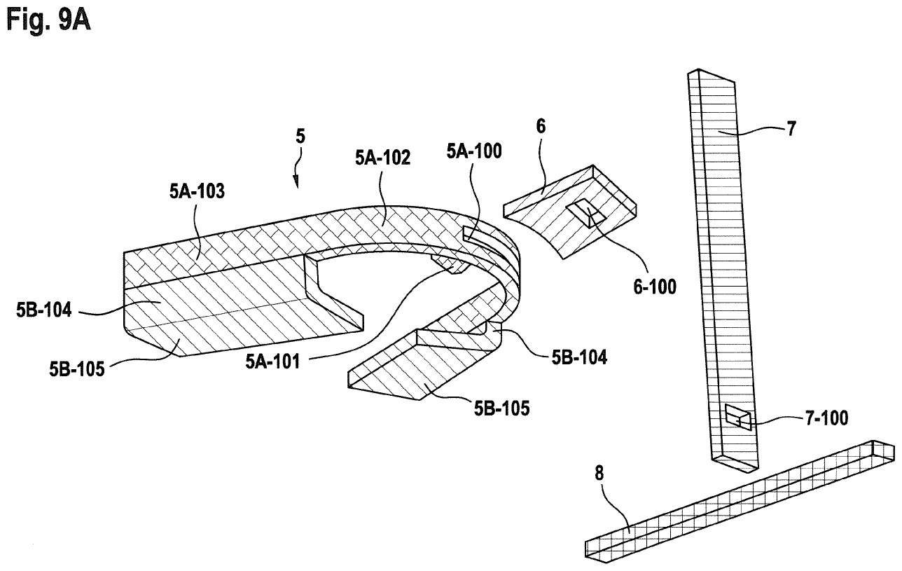

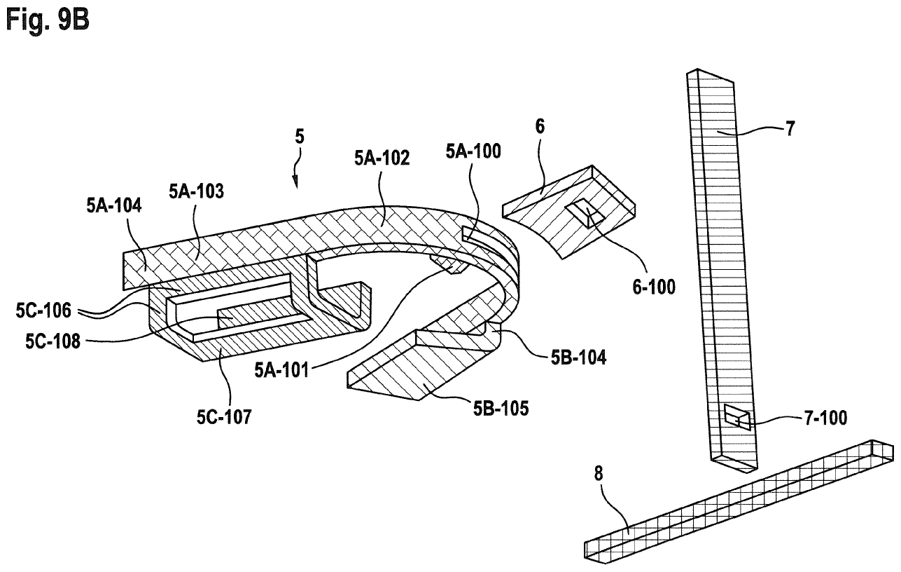

FIG. 9A shows an exploded view of the upper jaw bite fork 5 with the device 4 of FIGS. 1 and 2, and the upper jaw bite fork 5 with the first jaw relation element 6 of FIG. 8, respectively. FIG. 9B shows another possible design of the interrupted upper jaw bite fork portion, which is composed of a modification of portions 5B-104 and 5B-105 of FIG. 9A and comprises further cut-outs in the tooth crown area.

The first jaw relation element 6 is reversibly fixed in a cut-out 5A-100 of the upper jaw bite fork 5 by a clamping fit. This allows for the use of a device 4 on upper jaw bite forks with different sizes corresponding to the standard sizes of common upper jaw bite forks in dentistry. The second jaw relation element 7 is connected to the first jaw relation element 6 in a cut-out 6-100, and the third jaw relation element 8 is connected to the second jaw relation element 7 in a cut-out 7-100, both also via clamping fits. These clamping fits allow for a sufficiently firm connection between the elements, while still allowing for a displacement, in the sense of an adjustment in relation to each other, for alignment with the respective jaw relation.

Instead of clamping fits, guided fits with locking screws (not shown) may be used, and instead of displacement, guidance with gears via knurls (the latter not shown) may be used, provided that they meet the requirements for achieving an adjustment.

The further embodiment of the interrupted upper jaw bite fork portion (FIG. 9B), comprising the portions 5C-106, 5C-107 and 5C-108, does not extend all the way to the end of the tooth row Z17, Z27, comprises a circular distal portion 5A-104 and leaves the portions of the lateral and caudal surfaces of the tooth crowns partially exposed, thus allowing, in addition to the scanning of the cut-out tooth crown portions of the anterior teeth, or of the anterior and canine teeth, respectively, also for scanning these lateral and posterior cut-out tooth crown portions when the upper jaw bite fork 5 is inserted, thereby increasing the superimposition of different scans. Furthermore, to increase retention, the horizontal portion 5C-107 continues along the palatal crown side of the tooth crowns.

At this point, it is pointed out again that the embodiment shown in FIGS. 1 and 2, if applicable, together with FIGS. 7A and 7B, is in particular adapted for static registration of the jaw relation, and the embodiment shown in FIGS. 3 and 4, if applicable, together with FIGS. 7C to 7F, is in particular adapted for dynamic registration during lower jaw movement. The embodiment shown in FIGS. 1 and 2 may also be used for dynamic registration, but the dynamic range of application is limited compared to the embodiment shown in FIGS. 3 and 4.

In principle, such registrations of the jaw relations can only be successful if the upper jaw tooth crown portions and one end of the device as well as the lower jaw tooth crown portions and the other end of the device are within the detection range of intraoral scanners. This makes the success of the jaw relation registration depend on the technical conditions regarding hardware, e.g., intraoral scanner, and software, e.g., EDP, on the one hand, and on the technical conditions of the device, on the other hand.

It can be said that device 4, in particular means 45, can be applied as a device for providing data for determining the relative position of the spatial surface data of one or more tooth crowns and/or tooth crown portions in the lower jaw in relation to the spatial surface data of one or more tooth crowns and/or tooth crown portions in the upper jaw, wherein one portion is reversibly, but in a manner stable during manipulation, connected to at least one portion of the tooth crowns of the upper jaw, and another portion, either for one position of the lower jaw in one lower jaw position (FIGS. 1 and 2, FIGS. 7A and 7B), or for several positions of the lower jaw during a movement of the lower jaw (FIGS. 3 and 4, FIGS. 7C to 7F), rests against and/or on and/or close to at least one tooth crown portion of the lower jaw and covers it completely and/or not completely, and/or rests against, on or close to it or covers it, with impression material in between.

The device, in particular the means, may consist of several individual parts, namely the upper jaw bite fork, or a bite tray or impression tray or a paraocclusal bite fork at its one end, a first jaw relation element extending horizontally forward from the bite fork and out of the oral cavity of the subject, a second jaw relation element extending downward, preferably vertically, from the first jaw relation element and arranged outside the oral cavity of the subject, and a third jaw relation element at the other end of the device extending rearward, preferably horizontally, from the second jaw relation element into the oral cavity of the subject, wherein at least one of these elements is, in its axial direction, movably connected to at least one other element.

A lockable ball-and-socket joint may be arranged in at least one jaw relation element, and/or a hinge-like joint may be arranged in at least one jaw relation element, which allows for an orientation of the distal portion of the third jaw relation element in all spatial directions, including the orientation of the surface on the bottom (caudal) surface of this distal end according to the selected protrusion plane.

In addition, an incisal pin, preferably extending vertically, downwardly, on the frontside in relation to the lower jaw tooth row, may be arranged on the distal portion of the third jaw relation element, having its (dorsal) surface facing the tooth crowns, either for one position of the lower jaw in a lower jaw position (FIGS. 4 and 7A), or for several positions of the lower jaw during a movement of the lower jaw, rest against or close to at least one forward (ventrally, labially) facing tooth crown portion of the lower jaw (FIG. 3 in connection with 4, FIG. 7E in connection with FIG. 7F), and/or such comparable incisal pin is arranged at the rear side in relation to the lower jaw tooth row, having its surface facing the tooth crowns, either for one position of the lower jaw in a lower jaw position (FIG. 7B), or for several positions of the lower jaw during a movement of the lower jaw, rest against or close to at least one backward (dorsally, orally) facing tooth crown portion of the lower jaw (not shown), wherein none, one or both incisal pins can be moved according to the axial direction of the end point, so that, when both incisal pins are used (not shown), the lower jaw can be secured in a particular position against forward movement (protrusion), backward movement (retrusion) and bite down movement (jaw closure).

Furthermore, the front-side incisal pin may have its dorsal surface extend so far in the caudal direction that this surface rests, for one position of the lower jaw in a lower jaw position (FIG. 7A), or for several positions of the lower jaw during a movement of the lower jaw (see FIGS. 3 and 4), against or close to at least one forward (ventrally, labially) facing tooth crown portion of the lower jaw.

The front-side incisal pin 10 may be rotatably, or in an articulated manner, connected to the distal end of the third jaw relation element in the horizontal plane, amongst others, for aligning the front-side incisal pin such that it rests, for one position of the lower jaw in a lower jaw position (FIG. 7A), or for several positions of the lower jaw during a movement of the lower jaw (compare FIGS. 3, 4 and 7E with FIG. 7F), against or close to at least one forward (ventrally, labially) facing tooth.

The distal portion of the third jaw relation element may, according to the extension of the tooth crown surfaces of both jaw sides of the lower jaw (FIGS. 7C to 7E), further extend in the dorsal direction and lateral direction, wherein this design rests on and/or against and/or close to the occlusal surfaces and/or completely or partially covers them, and/or completely or partially rests on the occlusal surfaces, with impression material in between, and/or is reversibly connected thereto.

Further, in the device 4, the first jaw relation member 6 may be connected in an articulated manner to the second jaw relation member 7, and the cranial and caudal ends of the second jaw relation member 7 may be connected in an articulated manner to each other, and the caudal end of the second jaw relation member 7 may be movably connected to the third jaw relation member 8.

Furthermore, the device may be at its one end formed as an upper jaw bite fork such that it rests against and/or close to the upper jaw tooth crowns and/or more or less covers them, wherein at least part of the anterior tooth crowns is left out and other or further tooth crown portions may also be left out, and this upper jaw bite fork is manufactured individually after previously taking an impression in the dental laboratory, in a conventionally analog and/or digital manner according to the CAD/CAM method by milling, printing, sintering, etc., or is manufactured ready-made in an industrial process according to the common sizes for impression trays known in the field of dentistry.

Alternatively, the upper jaw bite fork may also be adapted according to a bite fork or paraocclusal bite fork known in the field of dentistry.

It is also possible to use a device with known three-dimensional surface data and/or ready-made portions for the device.

In addition, at least one of the jaw relation elements 6, 7, 8, and when using the incisal pin(s) 10, 11, these as well, may be provided with position markers (cf. marking 200 in FIG. 1 and FIG. 7A) and/or with markings, e.g., millimeter markings, colored markings, character markings, holograms, etc., which contain data about their spatial position on the three-dimensional surface of the respective element. The relative spatial allocation of the jaw relation elements, and, if applicable, of incisal pin(s) (10, 11), and the upper jaw bite fork to each other, as well as the allocation of the upper jaw bite fork to the upper tooth crown portions left out by the upper jaw bite fork and, if applicable, the allocation of the incisal pin(s) to the adjacent or spaced apart tooth crowns and/or tooth crown portions in the lower jaw 2, can thus be accelerated and made more precise using a digital (machine) registration method (e.g. optical scanner), since it is no longer necessary to completely register the entire surfaces of the means 45.

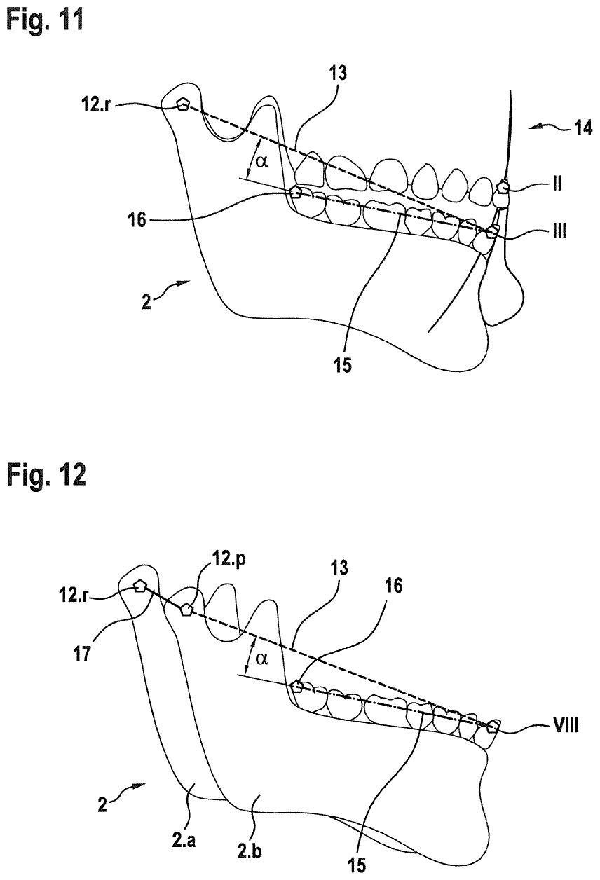

FIGS. 11 and 12 show two registration steps of the method according to the invention, which allow for the geometric identification of all jaw relation positions.

FIG. 11 shows a first registration step serving to determine the location of a first mandibular condyle center position 12.r. In this step, the jaw relation is actively and digitally registered, with the lower jaw 2 performing a rotational movement in the mandibular condyle center 12. In doing so, the incisal point 24 of the lower jaw 2 moves from II to III or from III to II (see also FIG. 5). A first distance 13 is then determined, extending between the first mandibular condyle center position 12.r and a, preferably predetermined, mesial point detected by scanning the lower jaw 2, e.g., on the circular path 14 resulting from the rotational movement of the lower jaw 2 between points II and III, here e.g., the point III (see FIG. 11). Subsequently, a second distance 15 extending between the mesial point, here for example point III, and a distal point detected by scanning the lower jaw 2, here for example point 16 on a distal tooth cusp of the tooth row, is determined; and an angle α between distance 13 and distance 15 is determined.

In the second registration step (FIG. 12), during a lower jaw movement, e.g., a lower jaw protrusion or a lower jaw laterotrusion (active or passive), the location of the same mesial and distal points that were detected when scanning the lower jaw 2 is determined with the incisal point, here for example VIII (see also FIG. 5) and 16, respectively. Subsequently, a second mandibular condyle center position 12.p is determined at the distal end of the distance 13 after this distance has been applied at point VIII at its mesial end and inclined in relation to distance 15 (between VIII and 16) by the angle α.

A distance 17 between the first mandibular condyle center position 12.r and the second mandibular condyle center position 12.p corresponds to the mandibular condyle path, which can be used to geometrically determine the jaw relation when knowing the distance 13 and the angle α.

1. A device for detecting jaw relation data of a person, comprising:
jaw relation elements comprising
a first jaw relation element, elongated and extending ventrally when used on the person and being configured for attachment to an upper jaw fitting element;
a second jaw relation element, elongated and extending transversely in relation to the first jaw relation element and caudally; and
a third elongated jaw relation element, elongated and extending transversely in relation to the second jaw relation element and dorsally, wherein the second jaw relation element is, in its direction of extension, movably connected to the first jaw relation element, and/or the third jaw relation element is, in its direction of extension, movably connected to the second jaw relation element such that the second jaw relation element or the third jaw relation element is configured to rest on at least one incisal or occlusal surface of one or more lower jaw tooth crowns, and/or configured to be arranged spaced apart from the one or more lower jaw tooth crowns in such a manner that it can be detected by a digital detection means together with the one or more lower jaw tooth crowns.

2. The device according to claim 1, characterized in that one or more of the jaw relation elements, in their direction of extension, each comprise one or more markings which can be detected by a detection means for unambiguous detection of positions of the jaw relation elements for identifying jaw relation positions.

3. The device according to claim 2, wherein the one or more markings are arranged at intersection points of the jaw relation elements for detecting their positions in relation to each other.

4. The device according to claim 2, wherein the one or more markings are configured for analog and/or for digital detection.

5. The device according to claim 2, wherein the upper jaw fitting element comprises at least one marking at or in an area bordering on cut-outs for detecting its position in relation to upper jaw tooth crowns or to lower jaw tooth crowns for digital machine detection.

6. The device according to claim 1, further comprising a first incisal pin extending transversely in relation to the second jaw relation element or the third jaw relation element and caudally and being movably and/or rotatably connected to the second jaw relation element or the third jaw relation element in a direction of extension thereof, wherein the first incisal pin can be positioned to be spaced apart from at least one lower jaw tooth crown or is configured to rest dorsally or ventrally against at least one lower jaw tooth crown.

7. The device according to claim 6, further comprising a second incisal pin extending transversely in relation to the second jaw relation element or the third jaw relation element and caudally and being movably and/or rotatably connected to the second jaw relation element or the third jaw relation element in the direction of extension thereof, wherein the second incisal pin is arranged opposite the first incisal pin for contact with or spaced apart from the at least one lower jaw tooth crown.

8. The device according to claim 7, characterized in that the first incisal pin and/or the second incisal pin each comprise, in their direction of extension, one or more markings which can be detected by a detection means for unambiguous detection of positions of incisal pins for identifying jaw relation positions.

9. The device according to claim 8, wherein the one or more markings are arranged at intersection points of incisal pins, and/or at intersection points between an incisal pin and/or both incisal pins and the second jaw relation element or the third jaw relation element for detecting their positions in relation to each other.

10. The device according to claim 8, wherein the one or more markings are configured for analog and/or for digital detection.

11. The device according to claim 1, wherein at least one jaw relation element comprises a dorsal section and a ventral section, which are connected to each other via an articulated joint.

12. The device according to claim 11, wherein the articulated joint is arranged such that a distal section of the at least one jaw relation element can be moved in at least three degrees of freedom.

13. The device according to claim 11, wherein a dorsal portion of the third jaw relation element further extends in a dorsal and lateral direction along lower jaw tooth crowns and rests against and/or close to occlusal surfaces of the lower jaw tooth crowns, and/or completely or partially covers them, and/or rests completely or partially on the occlusal surfaces with impression material in between, and/or is reversibly connected thereto.

14. The device according to claim 1, further comprising an upper jaw fitting element adapted as an upper jaw bite fork, which is dental arch-shaped, and which has, at least at open end sections, receiving areas configured to reversibly receive, in particular with aid of impression material, upper jaw tooth crowns, in a manner as to be stable during manipulation, and which is fixed to the first jaw relation element in an area of vertex of the arch.

15. The device according to claim 14, wherein the receiving areas of the upper jaw bite fork leave out an area of anterior tooth crowns and/or anterior tooth crown portions.

16. The device according to claim 15, wherein the receiving areas of the upper jaw bite fork also leave out further or other tooth crowns and/or tooth crown portions arranged distally to the anterior tooth crowns.

17. The device according to claim 14, wherein the upper jaw bite fork and the first jaw relation element are integrally formed.

18. The device according to claim 14, wherein the receiving areas of the upper jaw bite fork each have a cut-out on a side facing the upper jaw tooth crowns in an inserted state.

19. The device according to claim 14, wherein the receiving areas of the upper jaw bite fork have a plurality of small through-holes on their circumferential surface.

20. A method for detecting jaw relation data of a person using a device according to claim 1 and a scanner, wherein at least one marking is provided in an area bordering on tooth crowns and/or tooth crown portions on the upper jaw fitting element and on each of the jaw relation elements, which are detected by the scanner for unambiguous detection of positions of the jaw relation elements for identifying jaw relation positions.

21. The method according to claim 20, wherein at least one marking is provided on each of a first and/or a second incisal pin, which is detected by the scanner for unambiguous detection of positions of the first and/or the second incisal pin for identifying jaw relation positions.

22. The method according to claim 20, wherein the method comprises:
determining a first mandibular condyle center position by an active digital registration of a jaw relation, wherein a lower jaw performs a rotational movement in a mandibular condyle center;
determining a first distance between the mandibular condyle center and a predetermined mesial point on the lower jaw;
determining a second distance between the predetermined mesial point on the lower jaw and a predetermined distal point on the lower jaw;
determining an angle between the first distance and the second distance;
determining the positions of the predetermined mesial point and the predetermined distal point by a lower jaw movement with aid of a predetermined reference point on the lower jaw;
determining a second mandibular condyle center position with the aid of the first distance and the second distances and the angle therebetween; and
determining a mandibular condyle path.
